(19) United States
(12) Patent Application Publication
(10) Pub. No.: US 2013/0024459 A1
(43) Pub. Date: Jan. 24, 2013

(54) Combining Full-Text Search and Queryable Fields in the Same Data Structure

(71) Applicants: Nicolai Bodd, Stabekk (NO); Evan Matthew Roark, Asker (NO); Michael Susæg, Hosle (NO)

(72) Inventors: Nicolai Bodd, Stabekk (NO); Evan Matthew Roark, Asker (NO); Michael Susæg, Hosle (NO)

(73) Assignee: MICROSOFT CORPORATION, Redmond, WA (US)

(21) Appl. No.: 13/186,624

(22) Filed: Jul. 20, 2011

(51) Int. Cl. G06F 17/30

(52) U.S. Cl. 707/741; 707/E17.002

(57) ABSTRACT

A method for creating a search index is disclosed. A plurality of words found in one or more documents is identified. For each word of the plurality of words, one or more fields of the one or more documents in which the word can be found is identified. Using a computing device, a search index is created for each word of the plurality of words. The search index for each word of the plurality of words provides a mapping between the word and each occurrence of the word in each field of the one or more documents in which the word is found.

### BACKGROUND

Search engines may permit different types of searches. A full-text search permits search terms to be located in one or more available documents, regardless of where the search terms may be located in the documents. A search of queryable fields permits a user to specify one or more fields of a document that may contain the search terms.

Search engines typically make use of data structures known as search indexes to improve the efficiency and speed of searches. However, a full-text search typically requires a different search index than a queryable search. Requiring multiple search indexes increases the memory storage requirements for a search engine and increases the overhead of searches.

### SUMMARY

Embodiments of the disclosure are directed to a method implemented on a computing device for creating a search index. A plurality of words found in one or more documents is identified. For each word of the plurality of words, one or more fields of the one or more documents in which the word can be found is identified. Using the computing device, a search index is created for each word of the plurality of words. The search index for each word of the plurality of words provides a mapping between the word and each occurrence of the word in each field of the one or more documents in which the word is found.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### DESCRIPTION OF THE DRAWINGS

FIG. 1 shows an example system that supports full-text search and queryable fields in the same data structure.

FIG. 2 shows example components of the search processing module of FIG. 1.

FIG. 3 shows an example search index that may be implemented by the indexing module of FIG. 2.

FIG. 4 shows an example flowchart for creating a search index that can be used for both full text and queryable field searching.

FIG. 5 shows example components of the server computer of FIG. 1.

### DETAILED DESCRIPTION

The present application is directed to systems and methods for using a single search index to implement both full text search and search of queryable fields. Full text searching refers to searching for words within a preconfigured set of fields of documents. Search of queryable fields refers to searching for words within specific fields of documents. The systems and methods provide for organizing the single search index by words and by fields within words. By organizing the single search index in this manner, searches can be performed quickly and efficiently without unnecessary duplication of system resources.

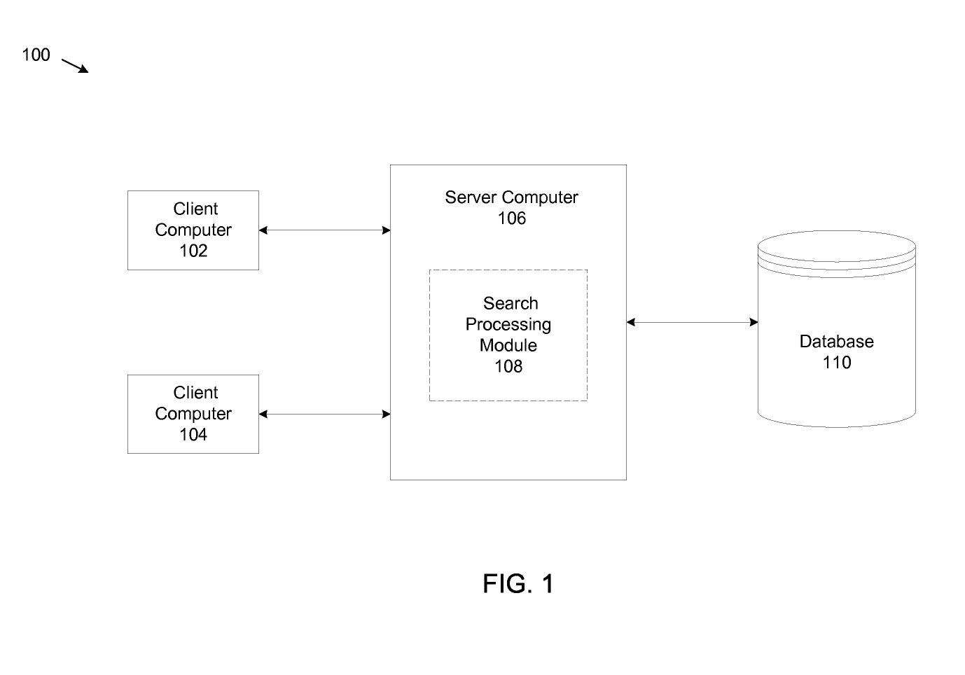

FIG. 1 shows an example system 100 that supports full-text search and queryable search in the same search index data structure. The example system 100 includes client computers 102, 104, server computer 106 and database 110.

The example server computer 106 includes a search processing module 108. Server computer 106 may be part of a server farm of multiple server computers. An example of a server computer that may be part of a server farm is the Microsoft SharePoint® Server 2010 collaboration server from Microsoft Corporation of Redmond, Wash.

The example database 110 stores one or more document that may be accessed via client computers 102, 104. The database 110 may be part of one or more server computers, for example server computer 106. In other embodiments the one or more server computers may store the one or more documents in lieu of database 110.

Client computers 102, 104 may access server computer 106 over a corporate Intranet or over the Internet. In examples, client computers 102, 104 may be part of a shared document management system such as the Microsoft SharePoint® document management system. In the shared document management system, one or more documents stored on server computer 106 or database 110 may be accessible by a user on client computer 102 or client computer 104.

When a user on client computer 102 needs to perform a search on the document management system, the user typically initiates an application including a user interface on client computer 102 and enters a search term in a query field of the user interface. The search term may be a word or a phrase that may be included in the one or more documents stored in the document management system. In examples, the user may request a full text search or the user may specify one or more fields in a document for which the search term may be located. For a full text search, the search term may be located anywhere in the document.

Documents may be structured to include identifiable parts or sections known as fields. Examples fields are titles, paragraph headings, sections of a document such as Abstract, Claims, Detailed Description, the full body of a document, etc. Other example fields are possible and other examples of sections are possible.

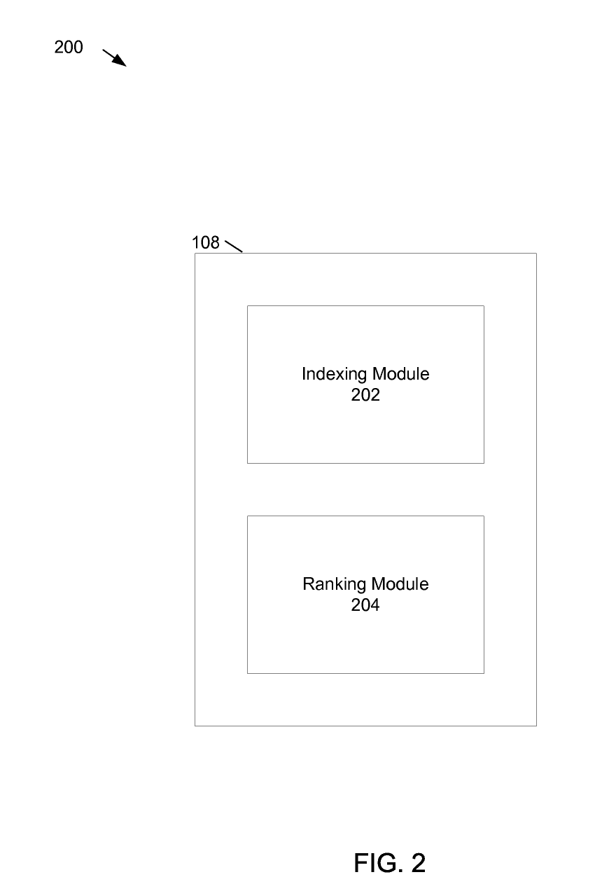

The example search processing module 108 receives search queries from client computers 102, 104 and performs a search of the document management system for documents containing the search queries. As shown in FIG. 2, the search processing module 108 includes an example indexing module 202 and an example ranking module 204. The indexing module 202 creates a search index for the documents stored in the document management system, as explained later herein. The ranking module 204 provides an ordered ranking of search results.

During a search for a word or group of words, the word or group of words may be found in a plurality of documents. In examples, the ranking module 204 may rank search results in relation to a number of occurrences of the word or group of words in a document, the more hits per document, the higher the rank. Similarly, when searching for a word or group of words in a particular field, the ranking module may rank search results in relation to a number of occurrences of the word or group of words in the field in a document, the more occurrences of the word in the field of a document, the higher the rank. Other ways in which the ranking module 204 may rank documents include determining how close search terms are to each other in a document, the closer the search terms in the document, the higher the rank.

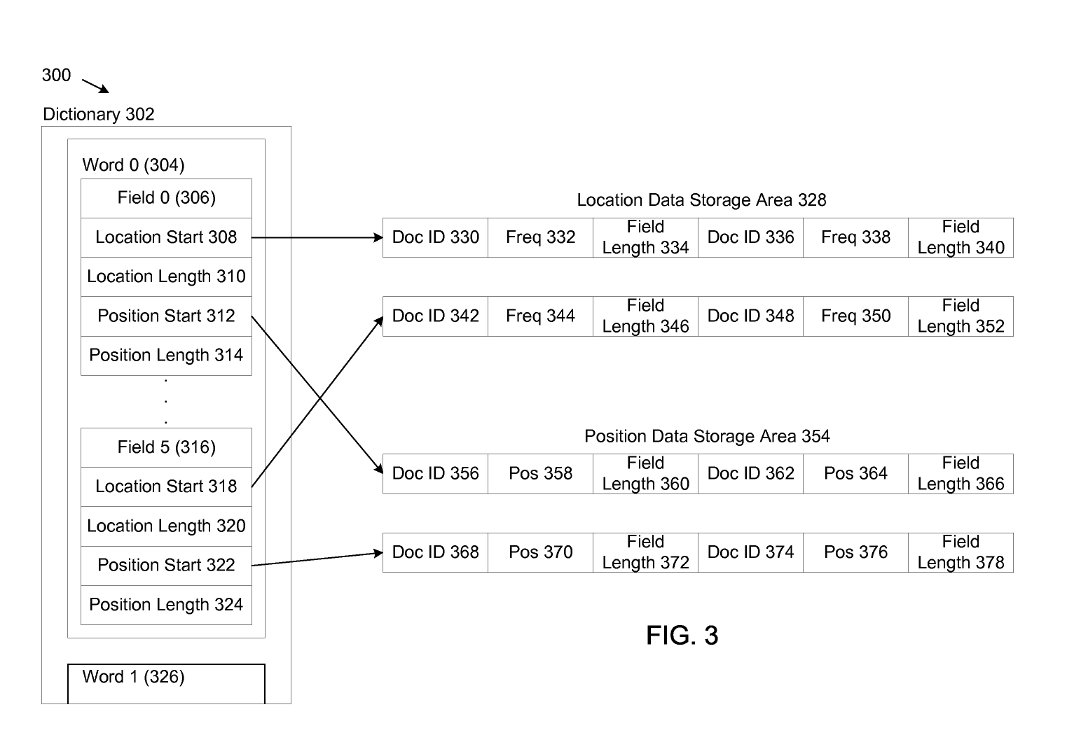

FIG. 3 shows an example search index 300 that may be implemented by the indexing module 202. The example search index 300 includes an example word dictionary 302. The word dictionary 302 lists one or more words that may be found in the one or more documents stored in the document management system implemented on server computer 106. Each of the one or documents includes a document identifier (doc ID) that provides a unique identification for the document. In this disclosure, all references to storage on server computer 106 or on database 110 may include storage on any component of the document management system implemented on server computer 106, including server computer 106, database 110 and any additional server computers and databases that are part of the document management system implemented on server computer 106, such as a SharePoint® collaboration server or database.

The word dictionary 302 includes index information for each word of the one or more words stored in the word dictionary 302. The index information provides mappings between each word of the one or more words and each field in which the word may occur for each document stored in the document management system. The mappings indicate the position in each document of each word in each field. In examples, instead of indicating the position in each document of each word in each field, the mappings may indicate only the frequency of occurrence for each word in each field of each document for which there is an occurrence of the word in the field of the document. In other examples, both types of mappings may be provided. One group of mappings may be provided to indicate the position of each word in each field and another group of mappings may be provided to indicate the frequency of occurrence for each word in each field of each document for which there is an occurrence of the word in the field of the document.

The word dictionary 302 orders each field sequentially per word. Thus, as shown in FIG. 3, for word 0 (304) field 0 (306) is stored before field 5 (316). The ordering of each field per word permits combining full text and field specific searching into a single search index. For example, a first field for a word may represent the full text of the document and succeeding fields for the word may represent specific parts of the document, for example a title of the document or a specific section of the document, for example an abstract section.

By organizing the search index by fields within a word, a full text search and a search for a word in a specific field may be performed via single disk read of the search index. This improves search performance and also avoids the need to provide separate search indexes for full text searching and for searching by specific fields. In addition, organizing the search index by fields with a word provides a degree of search schema flexibility. Rather than being confined to use a limited number of fields, as is common with search indexes, the word dictionary 302 may include a large number of fields and provide the ability to select a subset of this large number of fields dynamically during a search.

Schema flexibility also offers improvements in multi-tenant environments. A multi-tenant environment is where more than one customer uses the same search index. Because the word dictionary 302 includes a larger number of fields than is typically the case, individual customers can choose fields that are useful to them when doing a search.

As shown in FIG. 3, for each field in which a word in the word dictionary 302 can be found, the word dictionary 302 provides indexing to a location data storage area 328 and to a position data storage area 354. The location data storage area 328 provides information related to the frequency of occurrence of a word in a field. The position data storage area 354 provides information related to the position of a word in a document for each occurrence of the word in a field. The location data storage area 328 and the position data storage area 354 are located on server computer 106 or database 110.

The first word in the example word dictionary 302 is word 0 (304). The example word 0 (304) is found in a plurality of different fields on server computer 106, the first field being designated field 0 (306) and the last field being designated field 5. Only fields 0 and 5 are shown in FIG. 3. In examples, more or fewer fields may be used.

Field 0 (306) includes an example location start field 308, an example location length field 310, an example position start field 312 and an example position length field 314. The location start field 308 stores a pointer to a start of the location data storage area 328.

For each field for which a word occurs in a document, the location data storage area 328 includes a doc ID field, a frequency field and a field length field. For example, the location start field 308 points to the example doc ID field 330. The example doc ID field 330 provides an identifier for a document that includes one or more occurrences of word 0 in field 0.

The example frequency field 332 provides a number representing a number of occurrences of word 0 in field 0 for the document identified by the doc ID field 330. For example, if field 0 represents the title of the document, and word 0 occurs two times in the title, the example frequency field 332 has a value of 2. The example field length field 334 represents the length of field 0 for the document, for example the length of the title of the document identified by the doc ID field 330.

Similarly, the doc ID field 336 provides an identifier for another document that includes one or more occurrences of word 0 in field 0. The frequency field 338 provides a number representing a number of occurrences of word 0 in the document identified by the doc ID field 336 and the field length field 340 represents the length of field 0 in the document identified by doc ID field 336. Each of the example fields 330-340 typically occurs sequentially in memory so that memory offsets may be used to locate each of the example fields 330-340.

The example location length field 310 contains a value representing a length of the location data fields in the location data storage area 328 for the occurrences of word 0 in field 0. In the example shown in FIG. 3, this length corresponds to a memory area starting with the doc ID field 330 and ending with the field length field 340. In examples, the location length field 310 may be used as an offset to determine a start of location data for the next sequential field, in this case field 1. In examples, the start of location data for field 1 is equal to the location in memory of the doc ID field 330 plus the value specified in the location length field 310. The location data fields for occurrences of word 0 in field 1 are not shown in FIG. 3.

The example position data storage area 354 is an area of memory on server computer 106 or database 110 that stores position information for each occurrence of a word in a field in the one or more documents stored in the document management system. For each occurrence of the word in the field for a document, the position data storage area 354 includes information identifying the document, information identifying the position of the word in the document and information identifying the length of the field. For example, the doc ID field 356 provides an identifier for a document for which there is an occurrence of word 0 in field 0. In examples, the doc ID field 356 may identify the same document as the doc ID field 330. In other examples, the doc ID field 356 may identify a different document.

The position field 358 provides the position of word 0 in the document identified by the doc ID field 356 for a first occurrence of word 0 in field 0 in the document identified by the doc ID field 356. In examples, the position may be represented by a line number and a cursor position on the line corresponding to the line number. The field length field 360 represents the length of field 0 in the document identified by the doc ID field 356. Similarly, the doc ID field 362 provides an identifier for a document in which there is another occurrence of word 0 in field 0. If there is more than one occurrence of word 0 in field 0 for the document identified by the doc ID field 356, the doc ID field 362 may identify the same document as the doc ID field 356. The position field 364 provides the position of word 0 in the document identified by the doc ID field 362 for the occurrence of word 0 in field 0 in the document identified by the doc ID field 362. When there are multiple occurrences of word 0 in field 0 in a document, the position field 364 may represent a position of a second occurrence of word 0 in field 0 for the document identified by the doc ID field 356. The field length field 366 represents a length of field 0 in the document identified by the doc ID field 362.

The example position length field 314 contains a value representing a length of the position data fields in the position data storage area 354 for occurrences of word 0 in field 0. In the example shown in FIG. 3, this length corresponds to a memory area starting with the doc ID field 356 and ending with the field length field 366. In examples, the position length field 314 may be used as an offset to determine a start of position data for the next sequential field, in this case field 1. In examples, the start of position data for field 1 is equal to the location in memory of the doc ID field 356 plus the value specified in the position length field 314. The position data fields for occurrences of word 0 in field 1 are not shown in FIG. 3.

In a similar manner, the word dictionary 302 includes location start, location length, position start and position length information for each document field for which word 0 occurs in the document field. Thus, for document field 5, the word dictionary 302 includes the location start field 318, the location length field 320, the position start field 322 and the position length field 324. The location start field 318 is a pointer to a start of location data in the location data storage area 328 for occurrences of word 0 in field 5 for the one or more documents stored on server computer 106 or on database 110. The location length field 320 contains a value representing a length of location data fields for occurrences of word 0 in field 5 for the one or more documents stored on server computer 106 or on database 110. As shown in FIG. 3, there are occurrences of word 0 in field 5 in two documents, a document having a document ID of 342 and a document having a document ID of 348. For this example, the location length field 320 has a value representing an area of memory between the doc ID field 342 and the field length field 352. In other examples, word 0 may occur in field 5 in more or fewer than two documents.

The position start field 322 is a pointer to a start of position data in the position data storage area 354 for occurrences of word 0 in field 5 for the one or more documents stored on server computer 106 or on database 110. In the example shown in FIG. 3, there are two occurrences of word 0 in field 5. These two occurrences may be in the same document or they may be in different documents. The first occurrence is in a document identified by doc ID field 368 and the second occurrence is in a document identified by document ID 374. In examples, the document identified by doc ID field 368 may be the same document as identified by doc ID field 356.

The position length field 324 contains a value representing a length of the position data fields for occurrences of word 0 in field 5 for the one or more documents stored on server computer 106 or on database 110. In the example shown in FIG. 3, this value represents a memory area starting with the doc ID field 368 and ending with the field length field 378.

As discussed, the word dictionary 302 includes search index data for all words for which there is an occurrence of the word in one or more fields in the one or more documents stored on server computer 106 or database 110. However, because of space considerations, index data for only word 0 is shown in FIG. 3.

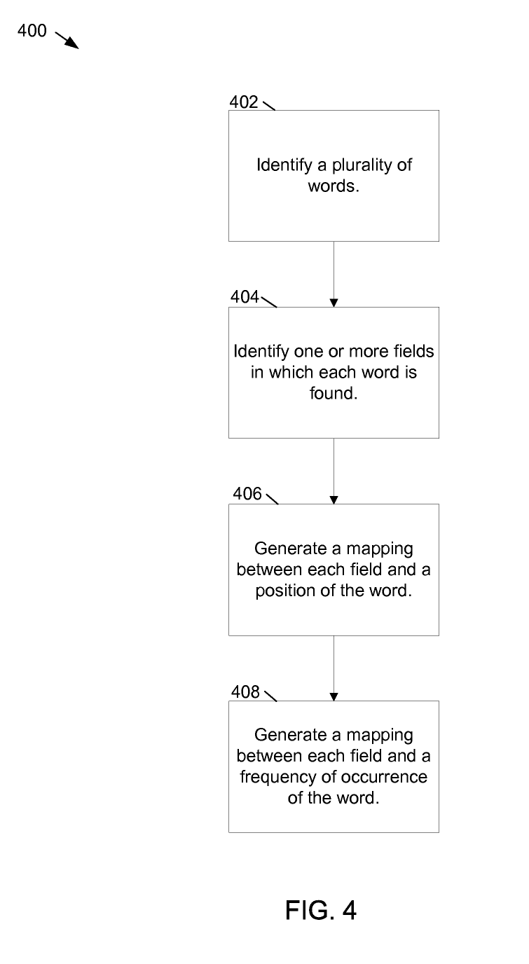

FIG. 4 shows an example flowchart of a method 400 for creating a search index that can be used for both full text search and search of queryable fields. At operation 402, a plurality of words is identified that is contained in one or more documents. The one or more documents are typically stored in a document management system, for example the Microsoft SharePoint® document management system. The one or more documents may be stored on one or more server computers in the document management system, for example server computer 106, or on one or more databases in the document management system, for example database 110.

At operation 404, for each word of the plurality of words, one or more fields are identified in the one or more documents in which the word is found. A field is an identifiable part of a document, for example a title, a heading, a paragraph, or the entire document. Other examples of fields are possible.

At operation 406, for each field in which a word is found, a mapping is generated between the word and a position of the word in each document in which the word is found in the field. The mapping provides an index that permits the word to be located for each occurrence of the word in the field in the one or more documents.

At operation 408, for each field in which a word is found, a mapping is generated between the word and a frequency of occurrence of the word in the field for each of the one or more documents in which the word is found in the field. The frequency of occurrence represents the number of times the word appears in the field for each of the one or more documents.

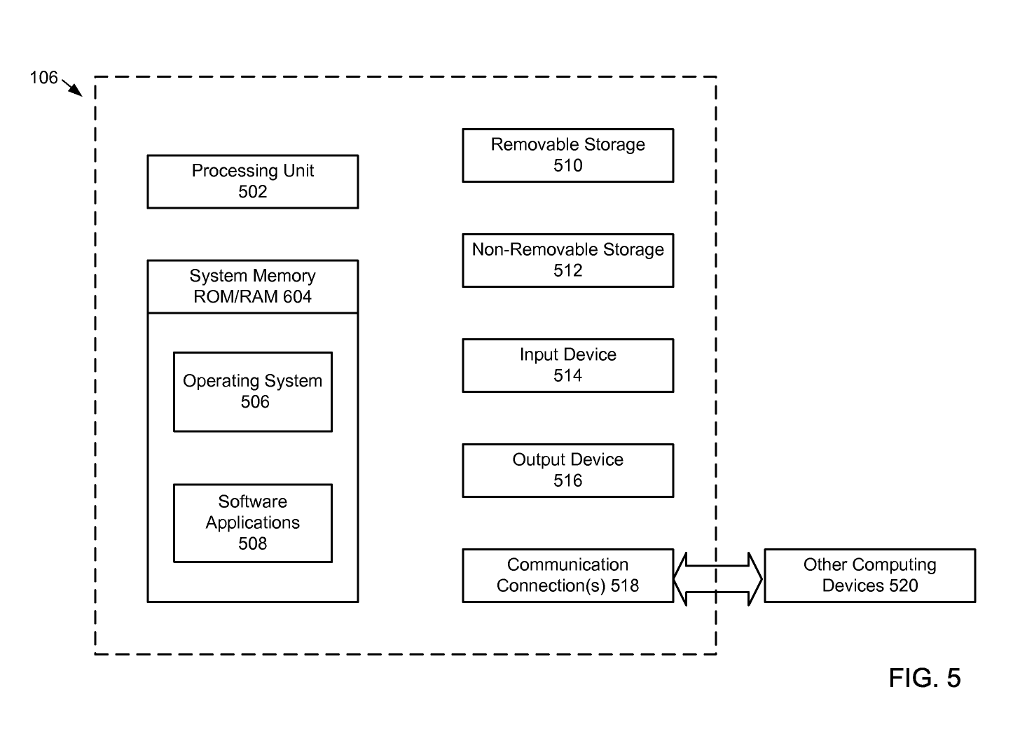

With reference to FIG. 5, example components of server computer 106 are shown. In example embodiments, server computer 106 is a computing device. Server computer 106 can include input/output devices, a central processing unit (“CPU”), a data storage device, and a network device.

In a basic configuration, server computer 106 typically includes at least one processing unit 502 and system memory 504. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of a server, such as the Microsoft SharePoint® Server 2010 collaboration server, from Microsoft Corporation of Redmond, Wash. The system memory 604 may also include one or more software applications 608 and may include program data.

The server computer 106 may have additional features or functionality. For example, server computer 106 may also include computer readable media. Computer readable media can include both computer readable storage media and communication media.

Computer readable storage media is physical media, such as data storage devices (removable and/or non-removable) including magnetic disks, optical disks, or tape. Such additional storage is illustrated in FIG. 5 by removable storage 510 and non-removable storage 512. Computer readable storage media may include volatile and nonvolatile, removable and non-removable media implemented in any method or technology for storage of information, such as computer readable instructions, data structures, program modules, or other data. Computer readable storage media can include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by server computer 106. Any such computer readable storage media may be part of server computer 106. Server computer 106 may also have input device(s) 514 such as keyboard, mouse, pen, voice input device, touch input device, etc. Output device(s) 516 such as a display, speakers, printer, etc. may also be included.

The server computer 106 may also contain communication connections 518 that allow the device to communicate with other computing devices 520, such as over a network in a distributed computing environment, for example, an intranet or the Internet. Communication connections 518 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The various embodiments described above are provided by way of illustration only and should not be construed to limiting. Various modifications and changes that may be made to the embodiments described above without departing from the true spirit and scope of the disclosure.

What is claimed is:

1. A method implemented on a computing device for creating a search index, the method comprising:
identifying a plurality of words found in one or more documents;
for each word of the plurality of words, identifying one or more fields of the one or more documents in which the word can be found; and
creating, using the computing device, a search index for each word of the plurality of words, the search index for each word of the plurality of words providing a mapping between the word and each occurrence of the word in each field of the one or more documents in which the word is found.

2. The method of claim 1, wherein each field corresponds to an identifiable part of the one or more documents.

3. The method of claim 1, wherein the mapping further comprises identifying each document in which each word of the plurality of words occurs in the one or more fields.

4. The method of claim 3, further comprising identifying a position of each word in the each document for each occurrence of the word in the one or more fields.

5. The method of claim 3, further comprising identifying a field length for each field of the one or more fields in which there is an occurrence of the word in the one or more fields.

6. The method of claim 1, wherein the mapping further comprises providing a first pointer from a first word of the plurality of words to a first document identifier, the first document identifier providing an identification of a first document of the one or more documents for which the first word occurs in a first field of the first document, the first field being one of the one or more fields.

7. The method of claim 6, further comprising determining a first position of the first word in the first document, the first position corresponding to a location of the first word in the first field of the first document.

8. The method of claim 7, further comprising determining a length of the first field.

9. The method of claim 1, wherein creating the search index further comprises determining a number of occurrences for each word of the one or more documents in each of the one or more fields in which the each word is found.

10. The method of claim 9, further comprising determining a length of each of the one or more fields.

11. The method of claim 1, wherein creating the search index further comprises providing a first pointer from a first word to a second document identifier for the first document, the second document identifier being used to locate frequency of occurrence data for occurrences of the first word in the first field of the first document.

12. The method of claim 11, further comprising determining a frequency of occurrence of the first word in the first field in the first document, the frequency of occurrence being the number of occurrences of the first word in the first field in the first document.

13. The method of claim 12, further comprising providing a determining a length of the first field.

14. The method of claim 1, further comprising implementing a full text search using the search index.

15. The method of claim 1, further comprising implementing a queryable search using the search index.

16. The method of claim 1, further comprising implementing a multi-tenant search using the search index.

17. An electronic computing device comprising:
a processing unit; and
system memory, the system memory including instructions that, when executed by the processing unit, cause the electronic computing device to:
identify a plurality of words found in one or more documents;
for each word of the plurality of words, identify one or more fields of the one or more documents in which the word can be found; and
create a data dictionary for the plurality of words and the one or more fields, the data dictionary being organized by the plurality of words and the one or more fields, the data dictionary providing a mapping between each word of the plurality of words and each occurrence of the word in each field of the one or more documents in which the word can be found.

18. The electronic computing device of claim 17, wherein for each of the one or more fields associated with each word, the dictionary includes a pointer to an area of memory that stores at least one document identifier, at least one frequency of occurrence and at least one field length, the document identifier identifying a document in which the each word occurs in the one or more fields, the frequency of occurrence representing a number of times in which the each word occurs in the one or more fields and the field length representing a length of the one or more fields.

19. The electronic computing device of claim 17, wherein for each of the one or more fields associated with each word, the dictionary includes a pointer to an area of memory that stores at least one document identifier, at least one position identifier, and at least one field length, the document identifier identifying a document in which the each word occurs in the one or more fields, the position identifier identifying a location in the document in which the at least one occurs in the one or more fields and the field length representing a length of the one or more fields.

20. A computer readable storage medium comprising instructions that, when executed by an electronic computing device, cause the electronic computing device to:
identify a plurality of words to be found in one or more documents;
for each word of the plurality of words, identify one or more fields of the one or more documents in which the word can be found, each field of the one or more fields corresponding to an identifiable part of the one or more documents;
create a search index for each word of the plurality of words, creation of the search index comprising:
identify each document in which each word of the plurality of words occurs in the one or more fields;
identify a position of each word in the each document for each occurrence of the word in the one or more fields;
identify a length for each field of the one or more fields in which there is an occurrence of the word in the one or more fields;
provide a first pointer from a first word of the plurality of words to a first document identifier, the first document identifier providing an identification of a first document of the one or more documents for which the first word occurs in a first field of the first document, the first field being one of the one or more fields;
identify a first position of the first word in the first document, the first position corresponding to a location of the first word in the first field of the first document;
determine a length of the first field;
determine a number of occurrences for each word of the one or more documents in each of the one or more fields in which the each word is found;
provide a second pointer from the first word to a second document identifier for the first document, the second document identifier being used to locate frequency of occurrence data for occurrences of the first word in the first field of the first document;
determine a frequency of occurrence of the first word in the first field in the first document, the frequency of occurrence being a number of occurrences of the first word in the first field in the first document;
identify a second document for which the first word occurs in a second field of the second document;
identify a first position of a second word in the second document, the first position corresponding to a first location of the first word in the second field of the second document;
determine a frequency of occurrence of the first word in the second field in the second document, the frequency of occurrence being the number of occurrences of the first word in the second field in the second document;
identify a second position of the second word in the second document, the second position corresponding to a second location of the first word in the second field of the second document; and
determine a length of the second field;
implement a full text search using the search index;
implement a queryable search using the search index; and
implement a multi-tenant search using the search index.
